(19) United States
(12) Patent Application Publication
(10) Pub. No.: US 2024/0367963 A1
(43) Pub. Date: Nov. 7, 2024

(54) FLUID DISPENSING TAP EQUIPPED WITH DISPENSING FLOW CONTROL ARRANGEMENTS

(71) Applicant: Vitop Moulding S.r.l., Alessandria (IT)

(72) Inventor: Diego NINI, Alessandria (IT)

(21) Appl. No.: 18/557,990

(22) PCT Filed: Mar. 30, 2022
(86) PCT No.: PCT/IT2022/050074

§ 371 Date: Oct. 30, 2023

(30) Foreign Application Priority Data
May 7, 2021 (IT) 102021000011786

(51) Int. Cl. B67D 3/04

(52) U.S. Cl. CPC B67D 3/045

(57) ABSTRACT

A dispensing tap for container fluids includes a support body; an elastic actuating button designed to allow and stop a fluid delivery, the elastic button being operatively connected to the support body; and a first stem or a second stem designed to allow and interrupt the delivery of fluid, the first stem or the second stem being contained in the support body and being operatively connected and activated by the elastic button, the first stem or the second stem having one of its ends in operative coupling with a fluid outlet end of the support body, the first stem or the second stem being equipped with closing lips at the fluid outlet end of the support body.

### BACKGROUND OF THE INVENTION

### 1) Field of the Invention

The present invention relates to a dispensing tap for fluids, and more particularly to a dispensing tap for dispensing fluids, preferably with a density higher than that of water (for example oil, detergent and the like) from flexible or rigid containers or Bag-In-Box containers (hereafter BIB). This tap is equipped with dispensing flow control arrangements.

### 2) Background Art

The tap described here constitutes an improvement with respect to that described in patent application PCT/IT2020/050296 in the name of the same Applicant, since it adds, to the countless advantages that the previous version already had compared to the prior art, devices and geometries that allow accurately managing the quantity of fluid delivered by the dispenser itself.

There is an inventive arrangement on the market that can be considered the progenitor of this type of tap: it is described in U.S. Pat. No. 4,452,425 B1. However, this prior art tap has limitations due to the conformation of its components and is able to deliver a predetermined quantity of non-modifiable fluid, since the conformation of its connection channel between the front cylinder and the container has a reduced section and the opening of the front stem is limited.

This leads to problems in “covering” the entire range of fluids on the market and limits oneself to operating only with fluids that will allow the fluid to pass easily through the sections present, however excluding a large slice of the market given by those fluids that are at the extremes of the viscosity diagrams, i.e. the highly viscous ones (which require large passages in order to allow the delivery of the same) or the low viscous ones (which, unlike the highly viscous ones, require smaller passages in order to slow down the output) difficult to dispense.

### SUMMARY OF THE INVENTION

Object of the present invention is solving the above problems, by providing a fluid dispensing tap formed by three plastic components that is equipped with arrangements that allow accurately managing the various fluids present on the market without these new geometries/devices being able to distort in any way the production lines already present on the market.

A further object of the present invention is providing a tap that uses components that are shaped in such a way as to use as less plastic as possible, lightening some geometries and therefore giving a “green” character to the application, which will require less plastic for its production and therefore less energy to produce it, as the production cycles themselves are shorter and less expensive: this will also have a positive effect on the final price of the dispenser itself.

A further object of the present invention is providing a tap as indicated above, which will allow “balanced” centering and controlled opening geometries to be obtained inside, which will not transmit any deformation to the critical sealing areas of the application itself, guaranteeing perfect fluid tightness.

A further object the present invention is providing a tap which optimizes the performance in terms of maximum deliverable flow, in comparison with the old version available on the market.

A further advantage is that the inventive tap adapts itself to existing production systems, without requiring changes to the users of the old version. In practice, it is possible to obtain all the advantages listed above, without changing the dimensions and functional geometries for medium (filling centers) and final customers (end user of the application).

The aforementioned and other objects and advantages of the invention, which will emerge from the following description, are achieved with a dispensing tap such as the one described in claim 1. Preferred embodiments and non-trivial variations of the present invention are the subject matter of the dependent claims.

It is understood that all attached claims form an integral part of the present description.

It will be immediately obvious that innumerable variations and modifications (for example relating to shape, dimensions, arrangements and parts with equivalent functionality) can be made to what is described, without departing from the scope of the invention as appears from the attached claims.

### BRIEF DESCRIPTION OF THE DRAWINGS

The present invention will be better described by some preferred embodiments, provided by way of non-limiting example, with reference to the attached drawings, in which:

FIG. 1 is a perspective view of an embodiment of the tap according to the present invention in its closed position;

FIG. 2 is a side view of an embodiment of the tap according to the present invention in its closed position;

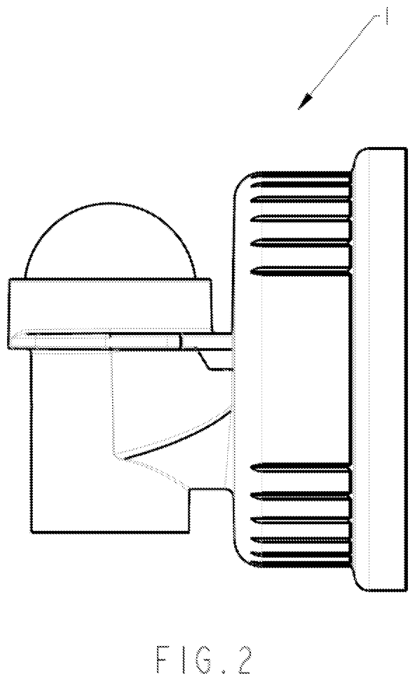

FIG. 3 is an exploded view of an embodiment of the tap according to the present invention in its closed position;

FIG. 4 is an exploded sectional view of the tap of FIG. 3;

FIG. 5 is a side and top sectional view of an embodiment of the prior art tap in its closed position, without the geometries and components shaped to solve the problems described above;

FIG. 6 is a side and top sectional view of a realization of the tap 2 in its open position at the Y-Y1 level (partial opening) of prior art dispenser, without the geometries and components conformed to solve the problems described above;

FIG. 7 is a side and top sectional view of an embodiment of the tap of the prior art in its open position at height Y (total opening) of the dispenser, without the geometries and components conformed to solve the problems described above;

FIG. 8 is a lateral and top sectional view of an embodiment of the tap of the prior art in its closed position of the dispenser, without the stem descent stopping geometry 4.1, but with the use of only the second stem 6 for low viscosity fluids; this stem, if used alone, does not allow obtaining the desired result of total control of the flow rate of the outgoing fluid;

FIG. 9 is a lateral and upper sectional view of an embodiment of the tap of the prior art in its open position at the Y-Y1 dimension (partial opening) of the dispenser, without the stem descent stopping geometry 4.1, but with the use of only the second stem 6 for low viscosity fluids;

FIG. 10 is a lateral and upper sectional view of an embodiment of the tap of the prior art in its open position at dimension Y (total opening) of the dispenser, without the stem descent stopping geometry 4.1, but with the use of only the second stem 6 for low viscosity fluids;

FIG. 11 is a side and top sectional view of an embodiment of the tap according to the present invention in its closed position with the geometries and components (in this case the stem for high viscosity fluids) shaped to solve the problems described above;

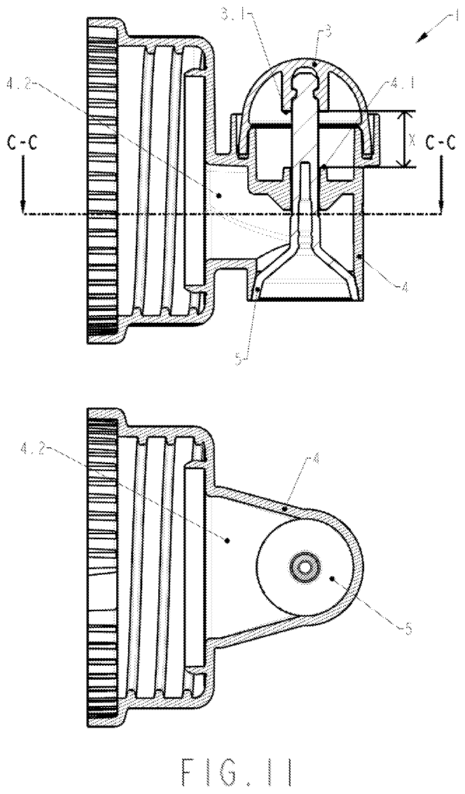

FIG. 12 is a side and top sectional view of an embodiment of the tap according to the present invention in its open position “X” with the geometries and components (in this case the stem for high viscosity fluids) shaped to solve the problems described above;

FIG. 13 is a side and top sectional view of an embodiment of the tap 1 according to the present invention in its closed position with the geometries and components (in this case the stem for low viscosity fluids) shaped to solve the problems described above;

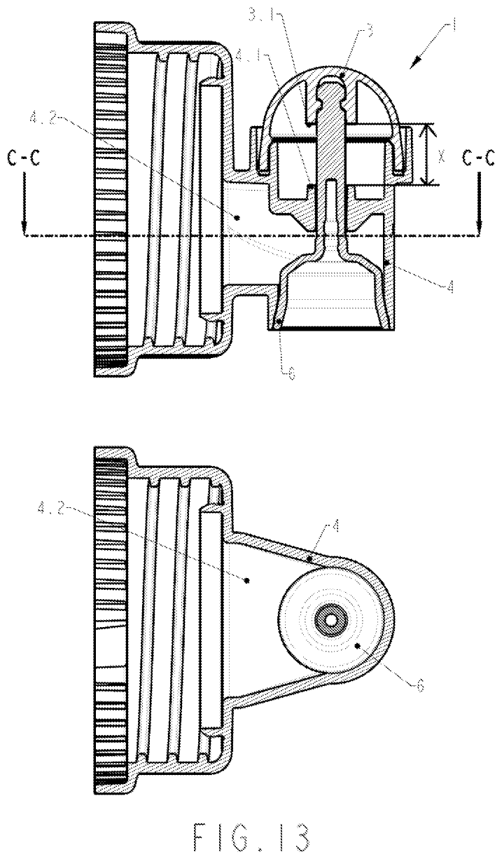

FIG. 14 is a side and top sectional view of an embodiment of the tap 1 according to the present invention in its open position “X” with the geometries and components (in this case the stem for low viscosity fluids) shaped to solve the above problems described; and

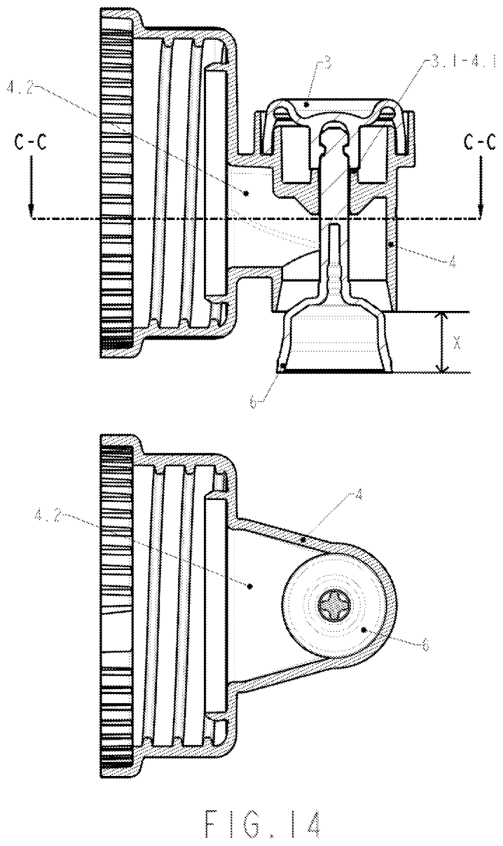

FIG. 15 is an exploded sectional side view of an embodiment of the tap according to the present invention.

### DETAILED DESCRIPTION OF PREFERRED EMBODIMENTS

The present invention refers to a fluid dispensing tap completely made of plastic material, which adapts itself, in a simple way and without requiring modifications, to existing systems which already use an outdated version of the cap.

The inventive tap also has a non-limiting application both to a flexible container, preferably of the BIB type using the appropriate version for BIB containers (not described here), and to a rigid container, in which two holes are generally made: one it is used to “house” the fluid dispenser/dosing cap, while the other is used to fill the drum; this second opening also acts as an “air inlet” in order to avoid the collapse of the rigid container and the consequent interruption of fluid delivery during the tapping phase of the fluid itself, and therefore during normal use of the container, in the event that a normal dispensing tap is connected to the other hole.

For most of the rigid containers on the market, the second hole (i.e. the one that is closed in the production cycle by means of a “normal” cap) also acts as an air inlet when using the tap (in practice it is so that the second hole remains at the top, during use, with respect to the tap, giving the user the possibility of being able to open it to let air in and therefore not to create that depression inside the container, which inhibits the use of the tap itself).

The fluid dispensing tap 1 of the present invention will preferably consist of three components: body 4, elastic button 3 with cap and first or second stem 5, 6; two of these, elastic button 3 and first or second stem 5, 6, are perfectly reusable when producing both the version for flexible containers, preferably BIB, and the version for rigid containers, modifying only the rear geometry of the main body.

The new tap 1 also complies with the new European and international directives on disposable plastic items (SUP), thanks to geometries that allow, unlike the old technologies on the market, to obtain dispensers which, once placed on the final containers, remain firmly and immovably bound to them.

Furthermore, thanks to the special conformation of the front dispensing channel and the positioning of the internal geometries, a tap 1 is obtained that is qualitatively superior to the competition on the market, and above all, a dispenser is obtained that allows most of the fluid contained inside to be tapped out of the containers, drastically reducing the residue the “end of life” level inside the container.

Again, due again to the conformation of the main bodies, there is a controlled dispensing flow which allows the new dispensing tap 1 to cover the entire viscosity spectrum of fluids present on the market, thus increasing its possibility of sale and replacement of obsolete technologies present on the world market today.

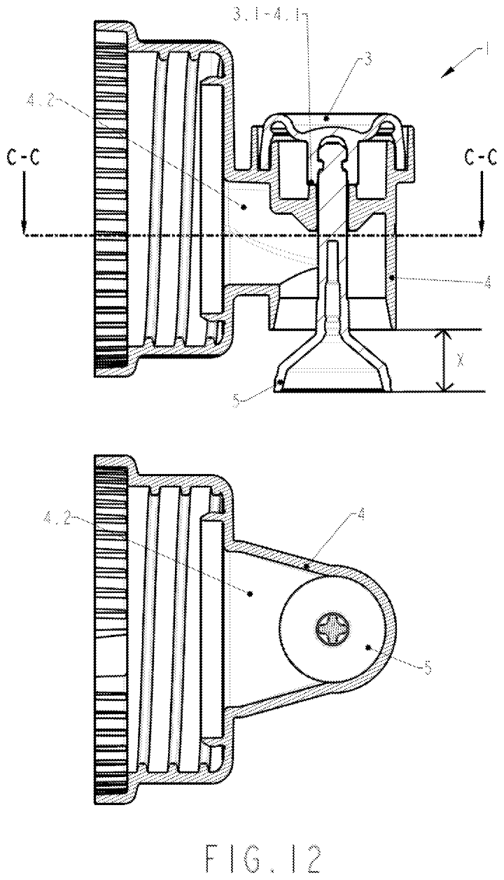

Moreover, due to the new internal conformation of the front cylinder and to the positioning of the centering and descent stop geometries of the button at a predetermined height according to the project “X” 4.1 (FIG. 12), the tap 1 allows a stop at a certain height “X” of the lower face of the button 3 (geometry 3.1 of FIG. 12). In addition, the cross shape with central cylinder 4.1 avoids the transmission of deformations to the main sealing cone, eliminating possible problems of deformed pieces that would cause fluid leaks from the application itself.

Furthermore, it is possible to provide the dispensing tap 1 with characteristics such as to make the version immovable and counterfeit-proof, once placed on the containers.

Furthermore, it is possible to optimize the use of plastic in the various components, increasing the “green” character of the application, in terms both of environmental impact, and of greater and faster production of the components themselves.

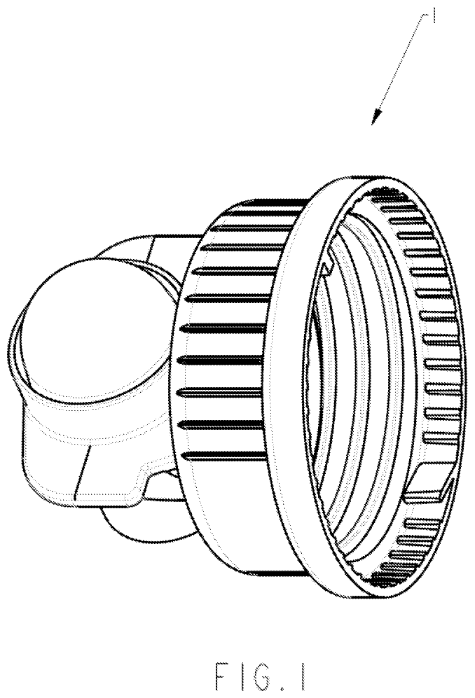

The interesting aspect is that it is possible to obtain the above advantages without requiring any changes to the customer who today uses the old-fashioned tap. In practice, the old dispenser is removed from the production line and replaced with the new tap 1 of FIG. 1, without having to change anything in the production cycle.

Furthermore, no modification is required to the current line that assembles tap 1, as the changes that allow the dispenser to control the flow have taken into consideration the existing production lines and have adapted to them.

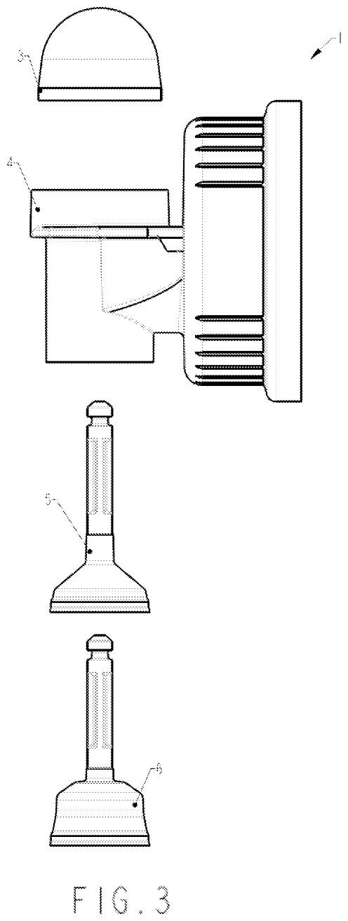

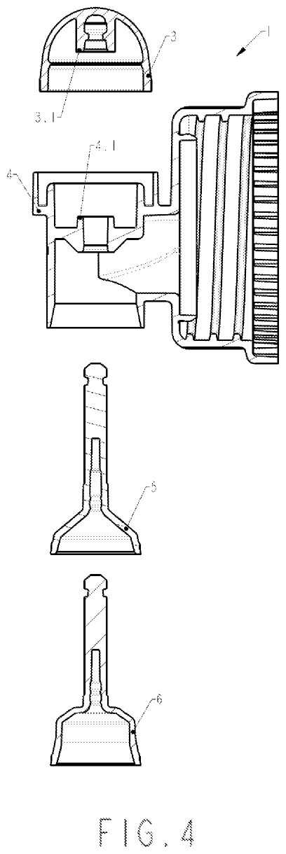

With reference to the Figures, a preferred embodiment of the fluid dispensing tap 1 of the present invention is shown, in its vertical application. It will be immediately evident that the dispensing tap 1 can also be used in its horizontal version, with minimal adjustments, within the reach of a common person skilled in the art. Going into the detail of the configuration described here and referring to FIGS. 3 and 4, the dispensing tap 1 is made up of three main components:
a support body 4;
an elastic actuating button 3 designed to allow and interrupt a supply of fluid, this elastic button 3 being operatively connected to the support body 4; and
a first stem 5 or a second stem 6, designed to allow and interrupt the delivery of fluid, the first or second stem 5, 6 being contained in the support body 4 and being operatively connected and operated by the elastic button 3.

The stem, according to the requirements, can be the first stem 5 for high viscosity fluids and therefore does not decrease the fluid passage section of the body 4, or the second stem 6 for low viscosity fluids, and in this case the bell of the second stem 6 decreases the fluid passage section of the body 4, effectively clogging the fluid outlet hole. In fact, to obtain its function of greater fluid passage, the first stem 5 has its end placed in operative coupling with the fluid outlet end of the body 4, which is shaped with a substantially triangular cross-section (i.e. with long inclined sides with respect to the axis of the first stem 5 and which lead to the closing lips of the outlet end of the body 4). In parallel, again to obtain its function of less fluid passage, the second stem 6 has its end placed in operative coupling with the fluid outlet end of the body 4, which is shaped with a substantially bell-shaped cross section (that is, with short sides almost perpendicular to the axis of the second stem 6 and which lead into long closing lips of the outlet end of the body 4 which are substantially parallel to the longitudinal axis of the second stem 6).

In its main conformation, leaving out the geometries and external shapes, as the dispenser tap 1 must aesthetically and geometrically comply with the version of the outdated tap on the market, so as not to require changes to the current production cycle, its new and innovative features will be listed below.

On the front part, there is a cylinder inside which all geometries useful for connection and hermetic sealing of the tap are obtained, which however will not be analyzed, as they are already described in Applicant's patent PCT/IT2020/050296. In detail, only the central geometry 4.1 of FIG. 4 will be described, added to the main body 4.

Furthermore, the new bell-shaped profile of the second stem 6 of FIG. 4 will be described in detail, which allows “clogging” the outlet hole to regularize the outlet of low viscosity fluids.

It can also be noted that, without the concomitance of the two modifications, namely the controlled descent stopping system 4.1 of the body and the new geometry of the second stem 6 of FIG. 4, the desired result cannot be obtained.

To better understand the technological innovation that allows, without distorting the current production cycle in any way, to control the fluid output flow in relation to the viscosity of the fluid to be dispensed, it is appropriate to analyze the condition in which the dispenser is today, with its characteristics.

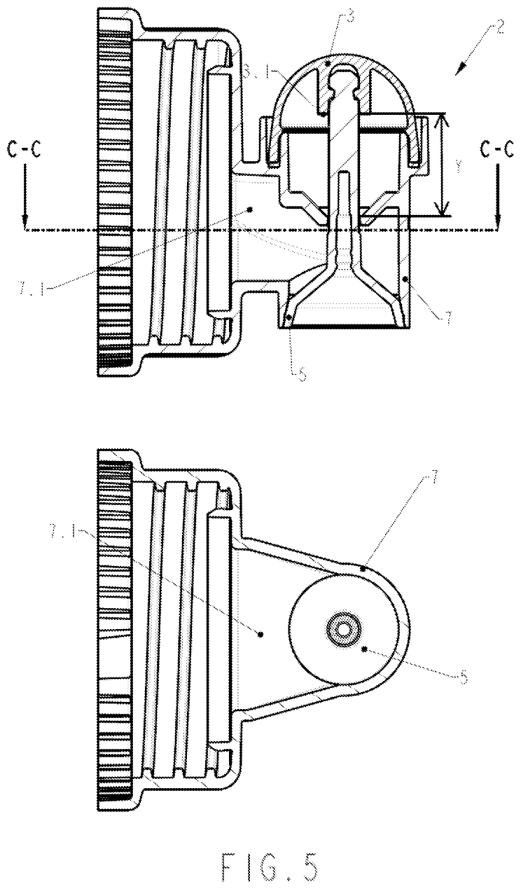

Referring to FIG. 5, a prior art tap 2 is shown, as it is currently produced and distributed by the Applicant. The feeding channel 7.1 of the tap 2 of FIG. 5 is trapezoidal in shape, in order to provide the greatest possible range.

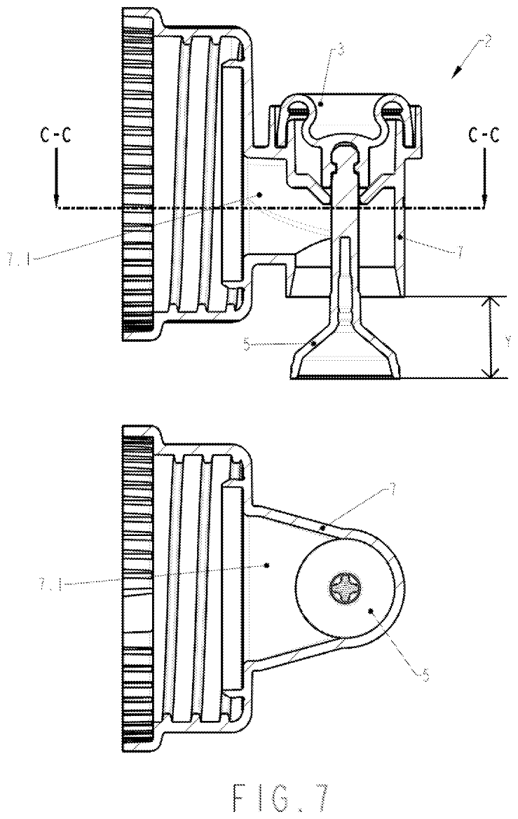

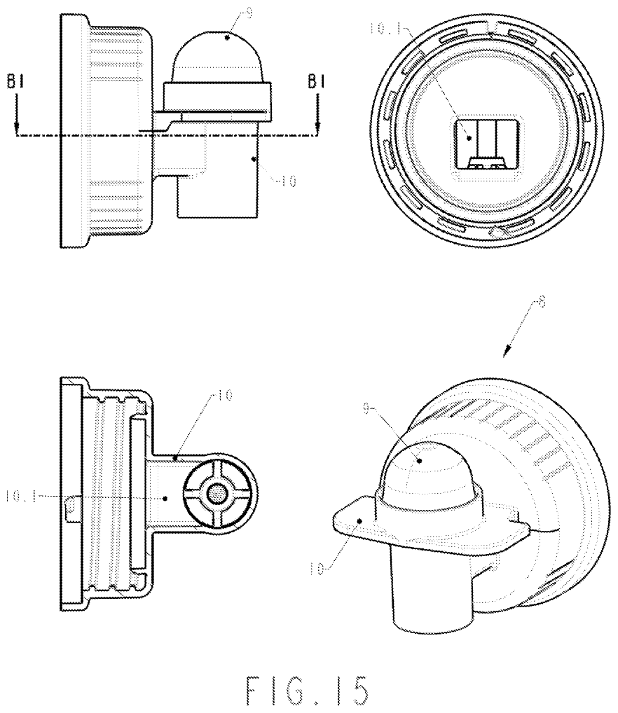

Nowadays, since there is no central descent stop on the body 7 of FIG. 5, the button, once pressed, has the possibility to go down to a maximum total altitude “Y” (if pressed to the maximum) in FIG. 7, thus delivering an enormous quantity of fluid compared to the tap 8 present on the market (shown in FIG. 15), which has on its body 10 a feeding channel 10.1 with a very small rectangular section, which certainly entails limitations in terms of delivery, especially for certain highly viscous fluids.

In any case, for the known tap, this entails a certain reduction in the field of application of the known dispensing tap 8 of FIG. 15. When, by pressing the upper button 9 of the tap 8 and not having a stop/limit switch geometry that allows the upper button 9 to be opened at a predetermined height, one finds oneself in the condition of having different results in terms of flow, based on the crushing force of the upper button 9 (and consequently on the force applied to it). Then, by pressing the upper button 9 to a greater or lesser extent, the value Y is varied to a greater or lesser extent, and consequently the flow of fluid that comes out of the tap 8.

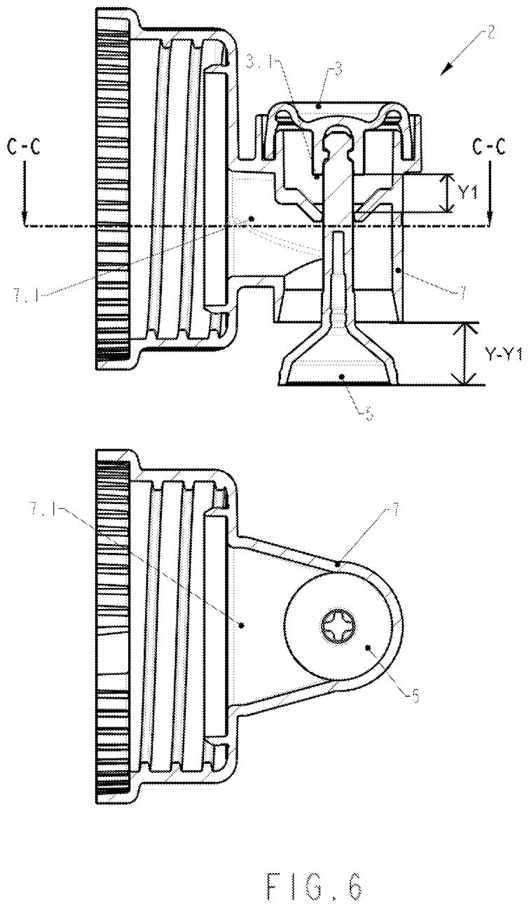

For example, it is noted in FIG. 6 that, if the button 3 is pressed less by a value Y1, the button 3 will open less (value Y-Y1) and the outlet flow rate will be less.

The descent Y dimension of the button 3 is equivalent to a Y dimension of the opening of the fluid outlet hole dictated by how much the first or second stem 5, 6 will free the fluid outlet hole.

But, given that reaching the opening level Y is difficult, unless you press button 3 fully and keep it pressed continuously at that precise level (rather unlikely situation), N possible openings Y-Y1 occur, where Y1 is the partial opening quota.

This determines the inconstancy and unrepeatability of the operation, causing countless results in terms of flow rate, and making it impossible to predetermine a desired constant flow rate.

This is considered a serious problem, as it does not allow the results to be repeatable and therefore, based on gender (man or woman) or age (child or adult), a variety of different results are obtained.

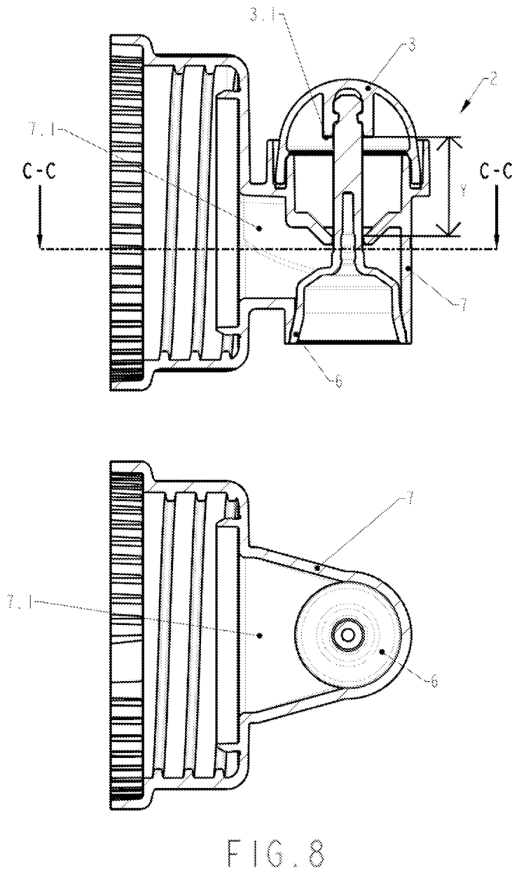

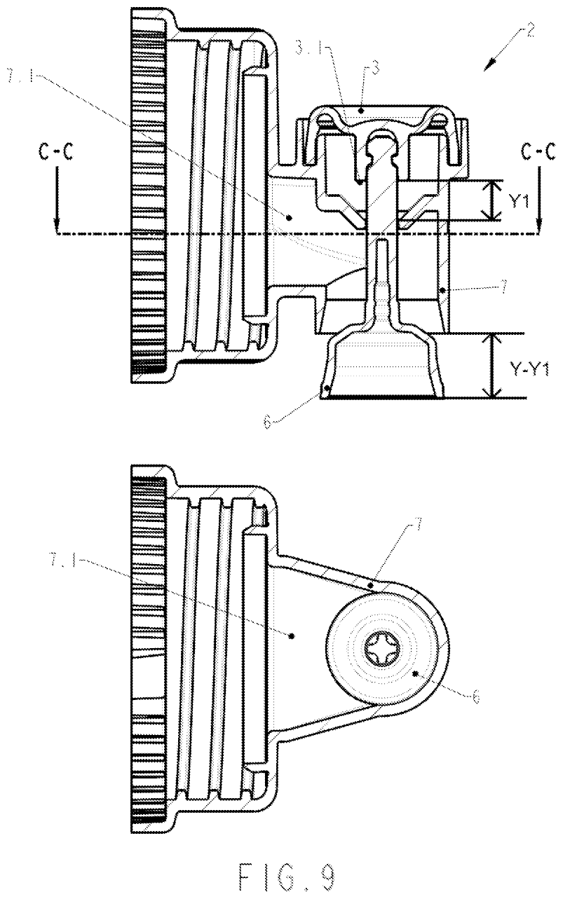

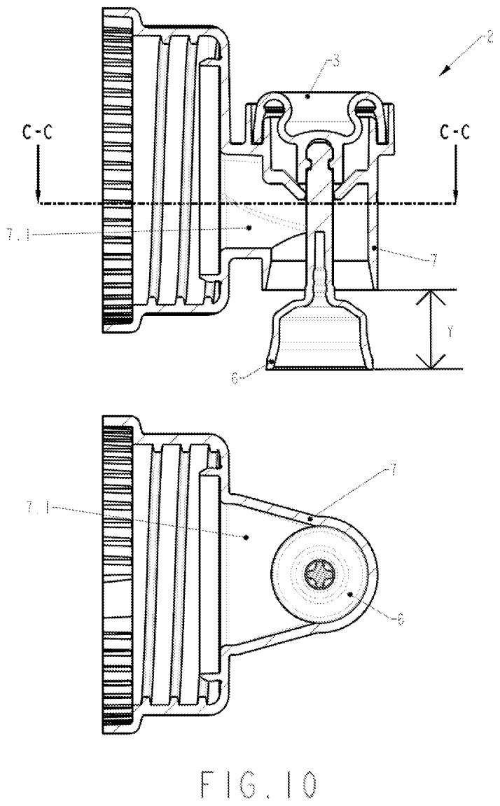

Furthermore, with the known dispensing taps 8, their use is not allowed for all fluids with different viscosities, since this non-predetermined opening share leads to dispensing problems (either in excess or in defect) of the fluid contained in the containers (also based on the viscosities of the fluids involved). Even by replacing the type of second stem 6, as shown in FIG. 8, it is not possible to obtain repeatable and constant results since, as for the previous version, it does not have a predetermined opening and therefore a predetermined and constant descent rate of the stem, multiple unsatisfactory results are obtained (Y-Y1 of FIG. 9 or Y of FIG. 10).

To eliminate this problem and give repeatability to the application (in terms of opening share and flow) and to also distinguish two versions that operate on two different markets (one for low density fluids and one for high density fluids), it was decided to study a new version of the body 4 of the dispensing tap 1 with a first central cylindrical geometry 4.1 which imposes a single opening “X dimension”, being operatively coupled, once the dispensing tap 1 is open, with the second central cylindrical geometry 3.1 of the elastic button 3, and imposing a predetermined and 100% repeatable opening quota.

In the preferred configuration illustrated, this first central cylindrical geometry 4.1 consists of a first annular recess 4.1 projecting inside the body 4 and extending in the opposite direction with respect to the opening direction of the first or second stem 5, 6. And correspondingly the second cylindrical geometry central 3.1 consists of a second annular recess 3.1 projecting internally of the elastic button 3 and extending in the same direction with respect to the opening direction of the first or second stem 5, 6. In this way, the first annular recess 4.1 and the second annular recess 3.1 are in mutual contact, as seen in FIG. 12, when the tap 1 is in its opening phase and pouring the fluids, obtaining an always equal and controlled quantity of poured fluid.

Furthermore, the two different geometries of the first or second stem 5, 6 of FIG. 4 will act in such a way as to close the fluid outlet hole to a greater or lesser extent (at maximum opening), and better manage the two high and low viscosity fluids.

With these geometries, the many variables that are present today are therefore eliminated and do not allow to adapt to all the products on the market.

Furthermore, these innovations have been designed so as not to cause any kind of problem both to end customers and also to existing production lines.

Furthermore, contrary to what is available on the market, the tap 1 is equipped with a channel 4.2 for dispensing fluids (the channel 4.2 being placed in the body 4 connected to the container from which to deliver a fluid) whose triangular cross-sectional conformation is similar to that of the channels 7.1 of the tap 2 of FIG. 5 (before the modification, i.e. the body 7 currently produced) and allows to make the most of the fluid passage sections and therefore allows to deliver a maximum quantity of fluid regardless of its viscosity: with the other known taps 8, which have a very small fluid passage channel 10.1 (FIG. 15), the application of the principles illustrated here is not allowed, as the basic concept that allowed to develop this idea for flow control starts from the fact that the dispenser tap 1, thanks to its conformation, already delivers the maximum possible fluid. The changes made in geometries 3.1 and 4.1 and the new second stem 6 have the purpose of regularizing the flow, deciding how much the maximum flow is clogged and make this action repeatable by opening the stem controlled by a predetermined descent altitude.

1-5. (canceled)

6. A tap for dispensing fluids from containers comprising:
a support body;
an elastic actuating button designed to allow and stop a fluid delivery, the elastic button being operatively connected to the support body; and
a first stem or a second stem designed to allow and interrupt a delivery of fluid, the first stem or the second stem being contained in the support body and being operatively connected and operated by the elastic button, the first stem or the second stem having one of its ends placed in operative coupling with a fluid outlet end of the body, the first stem or the second stem being equipped with closing lips at the fluid outlet end of the support body;
wherein:
the body is equipped with a first central cylindrical geometry designed to impose a single opening dimension of the dispensing tap, being operatively coupled, once the dispensing tap is open, with a second central cylindrical geometry with which the elastic button is equipped; and
the first stem is designed for high viscosity fluids and therefore does not decrease the fluid passage section of the body, the first stem having its end in operative coupling with the fluid outlet end of the body shaped with a substantially triangular cross-section, i.e. with sides inclined with respect to the axis of the first stem and which lead into the closing lips of the outlet end of the body.

7. The dispensing tap of claim 6, wherein the first central cylindrical geometry consists of a first annular recess projecting inside the body and extending in an opposite direction with respect to an opening direction of the first stem or the second stem, and the second central cylindrical geometry consists of a second annular recess projecting inside the elastic button and extending in the same direction with respect an opening direction of the firs stem or the second stem, the first annular recess and the second annular recess coming into mutual contact when the delivering tap is in its opening phase and pouring fluids, obtaining a quantity of poured fluid which is always the same and controlled.

8. The dispensing tap of claim 6, being equipped with a liquid delivery channel with a triangular cross-section conformation which allows delivering a maximum quantity of fluid regardless of the viscosity of the fluid, the liquid delivery channel being placed in the body connected to the container from which to deliver a fluid.

9. A tap for dispensing fluids from containers comprising:
a support body;
an elastic actuating button designed to allow and stop a fluid delivery, the elastic button being operatively connected to the support body; and
a first stem or a second stem designed to allow and interrupt a delivery of fluid, the first stem or the second stem being contained in the support body and being operatively connected and operated by the elastic button, the first stem or the second stem having one of its ends placed in operative coupling with a fluid outlet end of the body, the first stem or the second stem being equipped with closing lips at the fluid outlet end of the support body;
wherein:
the body is equipped with a first central cylindrical geometry designed to impose a single opening dimension of the dispensing tap, being operatively coupled, once the dispensing tap is open, with a second central cylindrical geometry with which the elastic button is equipped; and
the second stem is designed for low viscosity fluids and therefore decreases a fluid passage section of the body, the second stem having its end placed in operative coupling with the fluid outlet end of the body shaped with a substantially bell-shaped cross section, i.e. with sides almost perpendicular to the axis of the second stem and which end in closing lips of the outlet end of the body which are substantially parallel to the longitudinal axis of the second stem.

10. The dispensing tap of claim 9, wherein the first central cylindrical geometry consists of a first annular recess projecting inside the body and extending in an opposite direction with respect to an opening direction of the first stem or the second stem, and the second central cylindrical geometry consists of a second annular recess projecting inside the elastic button and extending in the same direction with respect an opening direction of the first stem or the second stem, the first annular recess and the second annular recess coming into mutual contact when the delivering tap is in its opening phase and pouring fluids, obtaining a quantity of poured fluid which is always the same and controlled.

11. The dispensing tap of claim 9, being equipped with a liquid delivery channel with a triangular cross-section conformation which allows delivering a maximum quantity of fluid regardless of the viscosity of the fluid, the liquid delivery channel being placed in the body connected to the container from which to deliver a fluid.
